(19) United States
(12) Patent Application Publication
(10) Pub. No.: US 2003/0056213 A1
(43) Pub. Date: Mar. 20, 2003

(54) Method and system for delivering a composite information stream over a computer network

(76) Inventors: James E. McFaddin, Dallas, TX (US); Justin Paul Madison, Garland, TX (US); Michael David Bigby, San Jose, CA (US)

Correspondence Address: STROOCK & STROOCK & LAVAN LLP, 180 Maiden Lane, New York, NY, 10038, US

(21) Appl. No.: 10/077,282

(22) Filed: Feb. 14, 2002

Related U.S. Application Data
(63) Continuation of application No. 09/859,562, filed on May 16, 2001.

(51) Int. Cl. H04N 7/10; H04N 7/025; G06F 17/60; G06F 15/16

(52) U.S. Cl. 725/32; 705/14; 709/219

(57) ABSTRACT

A system and method for delivering a composite information stream over a computer network includes a flow control system that is connected to multiple information sources. The flow control system receives data from two or more of these sources and from a data control manager. The system selectively controls the flow of data that is received from the data sources in response to commands from the data control manager to create the composite information stream. The composite information stream is passed to the encoder, which forwards it to the media player for display at end user processors. In accordance with the invention, commercial advertisements may be inserted into a television broadcast, and transmitted over the Internet to be displayed on a video monitor.

### CROSS-REFERENCE TO RELATED APPLICATION

This application is a continuation of application Ser. No. 09/859,562, filed May 16, 2001, now pending.

### FIELD OF THE INVENTION

This invention relates to a system and apparatus for controlling the flow of data from multiple sources. More specifically, the invention relates to a system and apparatus for automatically combining data from multiple sources to form a composite data stream.

### BACKGROUND OF THE INVENTION

Businesses invest a great deal of time and money developing new ways to reach potential customers. One common way that companies provide information about their products and services is to deliver commercials during television broadcasts. In one known method, commercials are simply inserted when there is an audible break in the broadcast. In another embodiment, they are played in response to audible tones that are embedded in the broadcast. For example, in one such method, a 25 Hz tone indicates that a commercial should start and a 35 Hz tone indicates that the commercial should end. Under most circumstances, these commercials are recorded on videocassettes, and loaded into video cassette recorders (VCRs) that have been connected to the broadcast system. An operator, who knows the order in which the commercials should be played, manually starts the appropriate VCR (or other playback device) at the appropriate time.

The tremendous growth in popularity of the Internet has encouraged businesses to use the Worldwide Web to attempt reach potential customers. The development of “streaming media” provides an efficient way to deliver live performances, television broadcasts and similar events to Internet users. Generally speaking, streaming media includes a set of images and sounds that are sent over the Internet, and played for the viewer in sequence as they arrive. Without streaming media, an Internet user would have to download an entire file before any audio or video could be played. Downloading such a file, which is usually very large, often consumes a substantial amount of time and is typically the source of considerable frustration. The availability of streaming media broadcasts encourages companies to insert advertisements and other information into the media stream as it is delivered to users over the Internet.

The use of audible gaps and tones to trigger the insertion of information into a data stream has the obvious drawbacks that are associated with a system that requires human intervention. While automated systems are available they also have problems. Such systems typically also store commercials and other information on videocassettes, which can be highly inefficient. It often takes a long time to properly position the tape to play the desired message, which makes it difficult to play commercials in any order other than that in which they have been recorded on the tape. Also, videocassettes tend to break and wear out with extended use, which requires the use of backup tapes.

Accordingly, although known apparatus and processes may be suitable for their intended purposes, a need remains for systems and methods for automatically inserting advertisements into a streaming media broadcast.

### SUMMARY OF THE INVENTION

The invention is generally directed to a system for controlling the flow of data from multiple sources to generate a composite information stream. In one embodiment, the system includes a plurality of data sources linked to a flow control system. The flow control system is configured to receive data from two or more of said plurality of data sources and from a data control manager, to selectively insert data received from the plurality of data sources into the data stream in response to commands from the data control manager, and to pass the merged data to an encoder.

In one embodiment, the data includes commercial advertisements. Files that contain the advertisements are downloaded to a computer that is linked to the encoder. The data control manager can also compile a list of the advertisements that have been transmitted to the media player.

Other embodiments of the present invention and features thereof will become apparent from the following detailed description, considered in conjunction with the accompanying drawing figures.

### BRIEF DESCRIPTION OF THE DRAWINGS

FIG. 1 illustrates a system that is capable of delivering a composite information stream over a computer network in accordance with an embodiment of the invention.

FIG. 2 contains a detailed illustration of a flow control system linked to associated hardware in accordance with an embodiment of the invention.

FIG. 3 is a block diagram that shows one way in which data can be selectively transmitted from multiple sources according to an embodiment of the invention;

FIG. 4 is a schematic illustration showing a flow driver linked to a flow controller in accordance with an embodiment of the invention;

FIG. 5 is a block diagram that illustrates in detail the manner in which stored data may be delivered to the flow control system in accordance with one embodiment of the invention;

FIG. 6 is a block diagram that illustrates in detail the manner in which stored data may be transferred to end user processors in accordance with one embodiment of the invention;

FIG. 7 illustrates data from multiple sources simultaneously being displayed on a video monitor; and

FIG. 8 shows how an event can trigger the display of data a video monitor in accordance with the invention.

While the present invention will be described in connection with certain embodiments thereof, it is to be understood that the invention is not limited to those embodiments. On the contrary, it is intended to cover all alternatives, modifications, and equivalents as may be included within the spirit and scope of the invention as defined by the appended claims.

### DETAILED DESCRIPTION OF EMBODIMENTS OF THE INVENTION

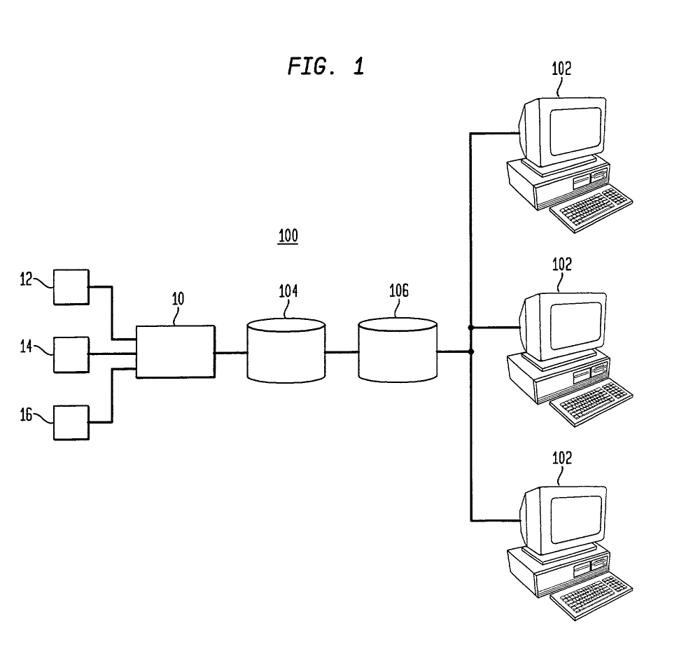

Referring now to the drawings which are provided to describe embodiments of the invention and not by way of limitation, FIG. 1 illustrates schematically, a system 100 which delivers a composite information stream over a computer network, such as the Internet. As used herein, the phrase “composite information stream” refers to a stream of information that could include one or more of several different items or types of data either sequentially or in some simultaneous combination. For example, a composite information stream could include live data from a television broadcast, data that is located on one or more storage devices such as a digital video disc (DVD) player, a video cassette recorder (VCR), a personal computer, various files from a file storage device, etc. or it could include some combination of data from these sources. Thus, for example, the stream could contain live data, then stored data, then live data. While the composite information is described as being part of a “single” stream, those skilled in the art will recognize that the various types of data could be split or duplicated, or that subsets of the data could be combined to generate two or more streams, each of which contains multiple types of data. While the delivery of such information over the Internet is a common use for system 100, it is to be understood that it could be used to deliver information over a local area network (LAN) wide area network (WAN) or other system.

System 100 generally includes multiple end user processors 102, a streaming media server 104, a web server 106 and a flow control system 10. As will be described in detail, flow control system 10 communicates with multiple information sources 12, 14, 16 and 18 to insert the data from these sources into a composite information stream. End user processors 102 typically include an Internet browser, such as Internet Explorer or Netscape Navigator, and a streaming media player such as Microsoft Windows Media Player, or Real Networks' Real Player. Various web sites are linked to system 100 by web server 106 for viewing by end users 102. End users 102 may access streaming media and various other forms of content by viewing web sites and selecting various links.

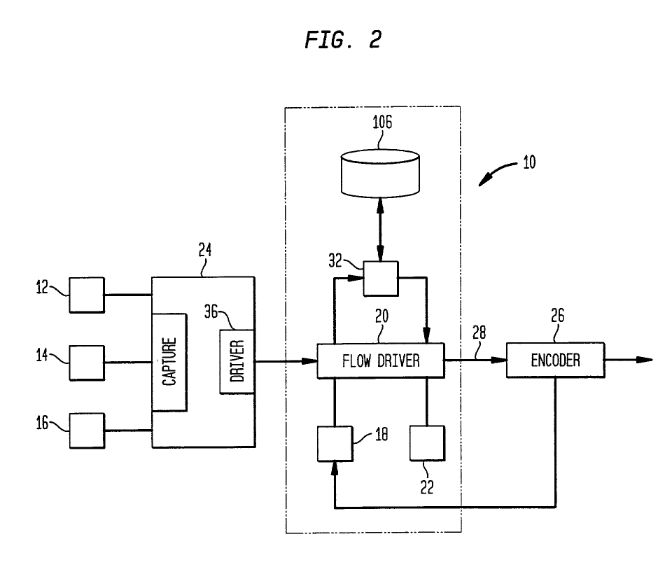

Turning to FIG. 2, flow control system 10 typically provides an intermediate link between an encoder 26 and a media delivery device 24, and it generally includes various computer executable files. Media delivery device 24 typically includes a capture portion which receives data from one or more input sources and a driver portion which forwards the received information to one or more output sources. In at least one embodiment of the invention, flow control system 10 is an independent module, physically separated from the media delivery device (e.g. in a separate electronic box or unit), yet linked to it to allow communication with at least the driver portion. Exemplary media delivery devices that may be used in accordance with the invention include audio cards such as those manufactured by Crystal Semiconductor, Inc. and Antex Electronics Corp. and video cards such as those manufactured by Osprey Communications, Inc. Encoder 26 is generally of the type that communicates with a streaming media server 104 to transfer an audio and/or video data stream from a radio or television broadcast to a media player as previously described. In one embodiment of the invention media delivery device 24, flow control system 10 and encoder 26 are located in separate electronic boxes.

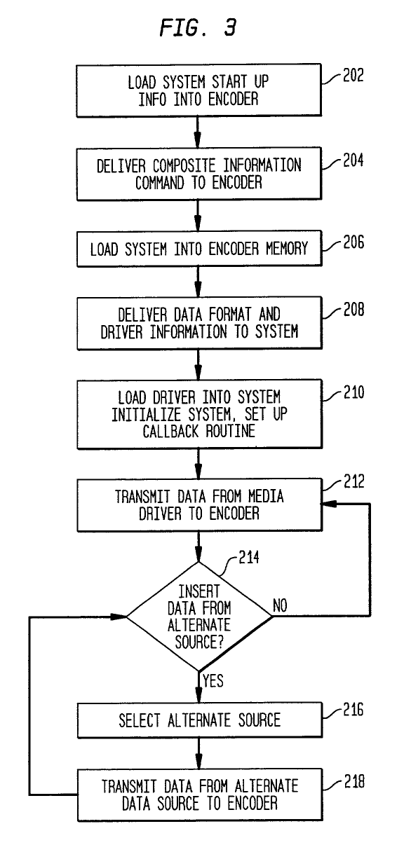

Referring to FIG. 3, delivering a composite information stream to end users 102 in accordance with the invention typically begins by loading startup information in encoder 26 as indicated in block 202. As stated above, the invention may be used with the Microsoft Windows Media Player. In such an embodiment, startup information will typically be provided in a configuration file that identifies the driver that will be used to deliver audio and/or video data from media delivery device 24. The configuration file will identify the device driver 36 that will be used, and may also describe the format in which the data should be delivered to encoder 26.

A command in the configuration file (which was loaded into the encoder memory at step 204) directs encoder 26 to deliver a composite information stream. Flow control system 10 is then loaded into the encoder memory as shown in block 206. Encoder 26 initializes flow control system 10 and delivers the data format and device driver information that was obtained from the configuration files as shown in block 208. Next, flow control system 10 loads driver 36, initializes it and sets up a callback routine to enable encoder 26 to receive audio and or video data from driver 36 as shown in block 210. Flow control system 10 passes the media data that it receives from driver 36 to encoder 26 at block 212, which forwards the data to the media player at end users processors 102.

Before data at driver 36 is forwarded by flow control system 10 to encoder 26, flow control system 10 determines from the startup information whether information from one or more alternate sources will be inserted into the media stream as indicated in block 214. More specifically, flow control system 10 continues to pass data from the media delivery device until it receives a signal that data from an alternate source should be inserted. When such a signal is received, flow control system 10 selects the designated alternate source as indicated in block 216, and passes data from the selected source to encoder 26. The data from this alternate source will be inserted into the data stream until the entire file has been delivered to encoder 26. Once the file has been inserted into the stream, flow control system 10 returns to block 214 to determine whether another alternate source should be selected to transmit another file. If so, the next alternate source is selected and the data is passed from the selected source to encoder 26. This continues until it is determined (i.e. at block 214) that no files from other sources are to be passed to encoder 26. Flow control system 10 then returns to media delivery device 24 and continues to pass data from media driver 36 to encoder 26.

Returning to FIG. 2, flow control system 10 controls the flow of data from multiple sources to deliver a composite information stream to end users 102. In an embodiment of the invention, two or more data sources 12, 14, 16 and 18 are linked to flow driver 20. As shown, some sources may be linked to flow driver 20 through media delivery device 24 (e.g. sources 12, 14 and 16), while others (e.g. source 18) are linked directly to flow driver 20. Sources 12, 14 and 16 may provide analog data that will be converted to digital data by media delivery device 24, or they may provide digital data that is forwarded to encoder 26 with limited (or no) processing. In contrast, sources such as data source 18 that are directly connected to flow driver 20 will typically be provided in digital form, or include an analog to digital converter or other device that will enable the data to be converted to a digital format prior to its delivery to flow driver 20. While the illustration shows multiple data sources 12, 14 and 16 connected to media delivery device 24 and only a single source 18 connected directly to flow driver 20, it should be understood that multiple sources could be directly connected to flow driver 20 and/or that a single source could be connected to media delivery device 24.

When the appropriate signal is received from data control manager 32, flow driver 20 selectively passes data from data sources 12, 14, 16 and 18 to encoder 26. Encoder 26 then returns to media delivery device 24 and continues merging data it provides into the composite stream. The information is then forwarded to the appropriate media player at end user processor 102 and displayed on a video monitor, personal digital assistant screen or other output device.

As indicated earlier, sources 12, 14, 16 and 18 may include live data, such as, for example, that from a television broadcast and one or more video cassette recorders, digital video disc players, digital satellite systems, and similar devices. Sources 12, 14, 16 and 18 may also include computers and other devices that provide stored data such as audio video interleaved files and graphics interchange files. Signals that trigger flow control system 10 to pass data from one of the additional sources will preferably be embedded or otherwise included in the broadcast. As stated earlier, these may be audible signals, such as tones or beeps, or they may be some other indicator that may be used in accordance with the invention. Signals could be used as they are delivered, or they could be embedded in the broadcast in one format (e.g. as an audible tone), and converted to another format (e.g. an electrical impulse) if desired. While embedded signals are commonly provided, those skilled in the art will recognize from the teachings herein that flow driver 20 could be triggered to vary the transmission source when the signals are provided independently such as, for example, by a timing device, by a computer that has been programmed to generate signals at an appropriate time, or by a manual process.

While the invention is described herein as delivering information from a single media delivery device 24 at a time, it is to be understood that the invention could be configured to simultaneously pass data from multiple devices. For example, several encoders 26, each of which is linked to a separate flow control system 10, could be linked to communicate with a single end user processor 102. Different media delivery devices 24 could then communicate with each flow control system to provide different types of data. Such an embodiment of the invention could be used, for example, to deliver a composite information stream that includes data from two or more audio and/or video drivers as well as one or more DVD players and VCRs.

Also, the output of a single flow control system 10 could be sent to multiple encoders 26, each encoding in a different manner. For example, it is often preferable to encode different types of information at different rates. More specifically, while some end users are connected to the Internet using 28 kbps modems, others are connected using 56 kbps modems. Using known devices, data encoded at different rates would have to be passed to different encoders 26, before they could be displayed on the associated output devices. According to an embodiment of the invention, information that is delivered to flow driver 20 by sources 12, 14, 16 and/or 18 may include signals that identify the appropriate encoding rate. Encoder 26 may be configured to read these signals to encode the data as directed.

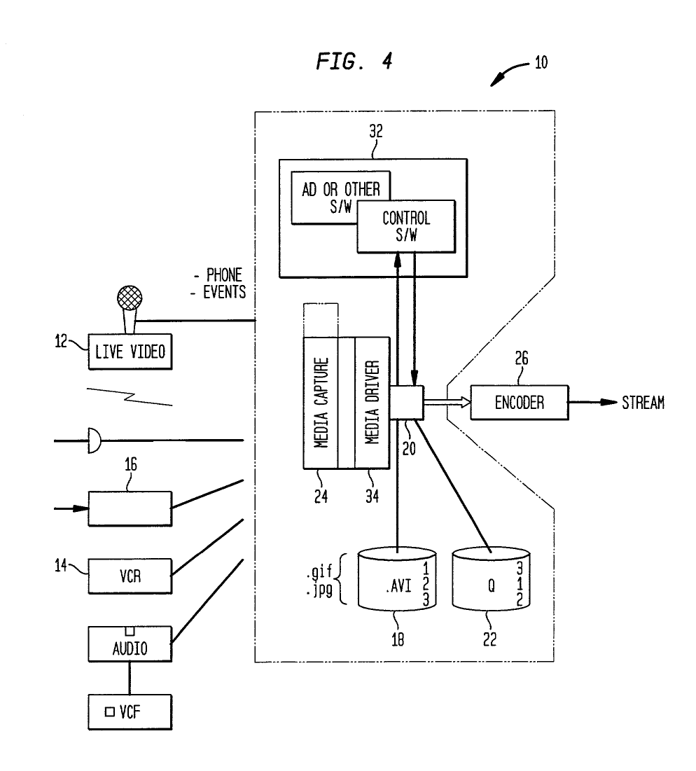

Turning to FIG. 4, flow driver 20 receives various commands from data control manager 32, which is typically an externally located software component. Data control manager 32 is used to designate the order in which data will be received from sources 12, 14, 16 and 18, encoded into a composite stream, and transmitted to end users 102. It should be appreciated that flow control system 10 can be used to combine many types of data for delivery to end users 102 as a composite stream. In one embodiment, flow control system 10 may provide updated information about content in a program that is being broadcast. For example, during a broadcast of a sports event, flow control system 10 may provide updated statistics about a player or team that is involved in the event. In another embodiment, information that allows a viewer to contact the appropriate source to order products or services that are associated with the program content may be provided. In one embodiment, flow control system 10 inserts commercial advertisements (“ads”) into a television broadcast.

The order in which the connected sources are selected to transmit data is stored in queue 22. The transmission order stored in queue 22 can be obtained in numerous ways, such as in a pre-programmed list, a computer program or interactively. In one embodiment, the list may be transferred or downloaded from another location, such as a personal computer that is directly connected to queue 22 or that is connected to queue 22, for example, via a local area or wide area network including, but not limited to the Internet. In yet another embodiment of the invention, telephone lines may be used to provide the information that is used to control the order in which data is transmitted from data sources 12, 14 16 and 18. In one such embodiment, the user may press the various buttons on the telephone key pad or dial to select numbers that are associated with the different data sources 12, 14, 16 and 18 to designate the order in which data should be transmitted from those sources. In another such embodiment, it may be desired to enable the system to recognize voice commands and convert them to a digital format as provided by sound cards such as those manufactured by Dialogic Corporation, Parsippany, N.J. The addition of such a device may allow a user to state a number that identifies the appropriate data source, or to state one or more words that identify the data that will be transmitted, such as the title, the name or subject of an advertisement. In another embodiment, voice recognition software may be incorporated directly into flow control system 10 to allow the user to issue such voice commands without the use of a Dialogic card. When delivering commands via telephone lines, it may be desired to adapt flow control system 10 to require users to enter a personal identification number or other identifying information in order to prevent unauthorized changes from being made. Those skilled in the art will recognize that the invention could also be adapted to accommodate the use of cellular telephones, personal digital assistants and other wireless devices.

In one embodiment of the invention, data control manager 32 communicates with web server 106 to obtain the data that will be stored in source 18. More specifically, data control manager 32 passes parameters that indicate the type of encoder 26 that is connected to flow control system 10, and the application that will be used to deliver the data that is stored in source 18, as well as the duration that will be available for playing the data (i.e. “break length” in the case of an advertisement file), and the type of files (e.g. AVI, WAV) that can be stored. In response, web server 106 provides a list of the names of files that have been previously delivered to the encoder that satisfy the parameters. The actual files may be delivered to encoder 26 in several ways. For example, in one embodiment of the invention, the files are downloaded from web server 106 via a scheduled job. Such a job could run at scheduled intervals to deliver new file.

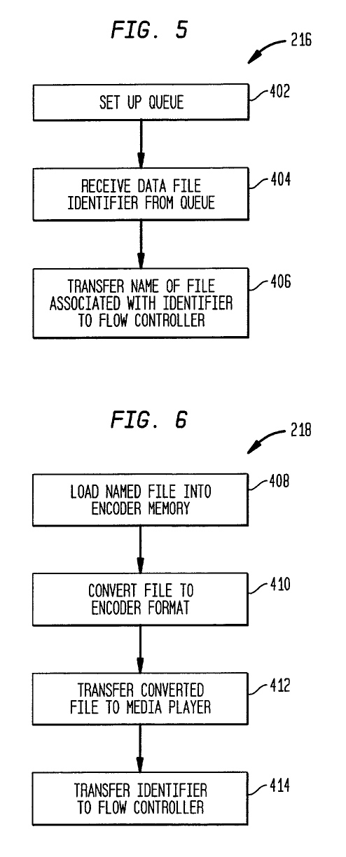

As indicated in FIG. 3, once an appropriate signal is received at block 214, flow control system 10 selects an alternate source and passes data from the selected source until the desired amount of data has been delivered to encoder 26. In one embodiment, this portion of the invention operates as shown in FIGS. 5 and 6. First, data control manager 32 sends a command to flow control system 10 to set up queue 22 as indicated in block 402. The various data files that may be delivered by sources 12, 14, 16 and 18 are associated with identifiers, which are typically numerical values. The set up of queue 22 in block 402, typically includes placing the numbers that are associated with these files in the order in which the files are to be delivered to encoder 26. When the appropriate signal is detected in block 214 of FIG. 3, data control manager 32 sends the name of the file that is associated with the number provided by queue 22 to flow controller 10 at block 406.

Turning next to FIG. 6, the named file is then loaded from the selected source into a memory linked to encoder 26 at block 408. The file is converted to a format that can be used by encoder 26 as indicated in block 410 and is stored in the encoder 26 memory. The converted data file is passed to the media player at block 412 for display on end user processors 102. A unique data identifier is also passed to data control manager 32 at block 414 to indicate that the requested data has in fact been transmitted to encoder 26. If desired, information about the files that are transmitted to the media player can be used by other applications. For example, the system can be set up so that each time a commercial advertisement is transmitted to the media player, data control manager 32 memorializes the event to create an advertisement log that can be used to show what advertisements have been played.

Once the designated data has been played by the media player, data control manager 32 will refill queue 22 with new file information and reset it. As stated earlier, the invention may be used to deliver information to a Windows Media Player. These embodiments of the invention will typically carry out file conversion using application programming interfaces that are provided by a software development kit, such as those that are provided by Microsoft Corp. to convert files for use by various media players.

In one embodiment of the invention, the data that is downloaded from web server 106, stored in source 18 and transmitted to encoder 26 includes commercial advertisements. The assignment and transmission of unique identifiers allows for the tracking of the advertisements, and provides a way to verify that requested advertisements have been played.

In one embodiment, computer generated files, such as audio video interleaved files and/or a graphics interchange files are stored in source 18. These files may be compressed, for example, to comply with JPEG and/or MPEG standards. It should be noted that the system that is placed between the computer generated data and flow driver 20 may perform “AND” and “OR” operations. Thus, in one embodiment, flow controller 10 may direct flow driver 20 to transmit data from only one source 12, 14, 16 or 18. In such an embodiment, the data from both sources may be passed to flow controller 10, which will dictate which of the two sources should be connected to flow driver 20 for the transmission of data.

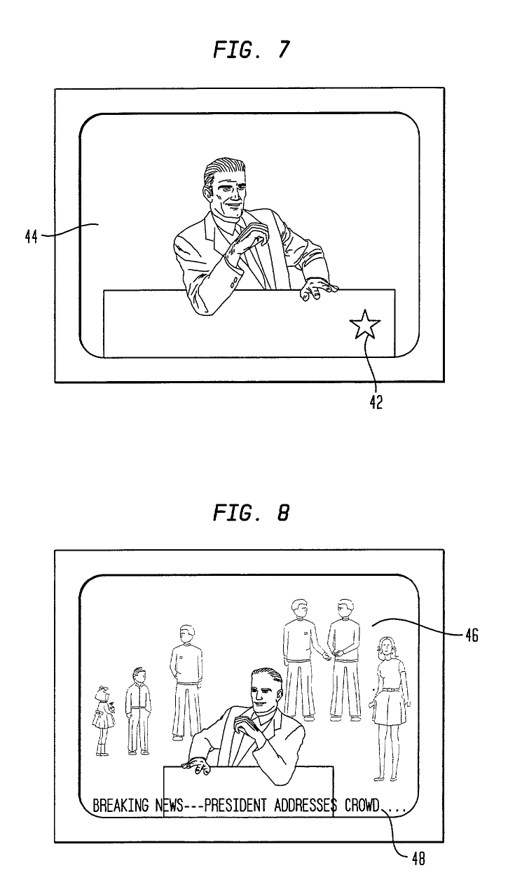

As illustrated in FIG. 7, in another embodiment, flow controller 10 may direct flow driver 20 to simultaneously transmit data from two or more sources 12, 14, 16 or 18. Such an embodiment may, for example, allow an image 44 from a television broadcast to simultaneously be displayed with a symbol 42 such as a logo or a watermark that identifies a sponsor, content provider or other entity that may be associated with the information that is being transmitted. In this embodiment, flow controller 10 may direct flow driver 20 to receive the data from both sources to cause both sources to pass data to encoder 26 simultaneously.

Referring to FIG. 8, in still another embodiment of the invention, the occurrence of one or more events may be used to initiate the transmission of data from sources 12, 14, 16 and 18. For example, information from a live telecast 46 such as a sports or news event may be transmitted to one or more data sources 12, 14, 16 and 18. Queue 22 may then select the appropriate data source when it receives an appropriate signal (e.g. at the beginning or end of the event), to insert information 48 which may include video clips, still images, reports, highlights, summaries, scores or other information from the event into the video stream. In one embodiment of the invention, breaking news may be fed to one of data sources 12, 14, 16 and 18 along with a signal that triggers flow control system 10 to immediately transmit the data from the source. A broadcast may then be interrupted to provide the breaking news to the viewer in response to the signal. In another embodiment, video from a sports event may be fed to one of data sources 12, 14, 16 and 18. A signal may be generated to indicate that the event has concluded, to cause queue 22 to select the associated data source when the next (or a designated) signal that is embedded in the broadcast is received, to display the final score and to play a video clip with highlights of the event. Thus, as indicated by these exemplary embodiments of the invention, signals may be assigned different priority levels, to cause some information to interrupt broadcasts when necessary and to allow the system to deliver other information only at regularly scheduled breaks.

In one embodiment of the invention, tones that are embedded in a broadcast may be detected by data control manager 32 using a hardware based detection procedure. In such an embodiment, a signal may be transmitted to a software component that runs on a device that is external to flow control system 10 when such tones are detected. The software component on this separate piece of hardware may then send a command to data control manager 32 to request playing of the ad designated by queue 22. The command is then forwarded to flow control system 10 which selects and plays the ad. A signal is preferably transmitted to data control manager 32 when flow control system 10 finishes playing the ad, and queue 22 is filled with another ad. In one embodiment, data control manager 32 sends a command to flow control system 10 to cause an ad that was identified during queuing to be played.

In another embodiment of the invention, a software based tone detection process may be included in flow control system 10 and data control manager 32 may use this process to encode information from the various sources into the composite data stream. In such an embodiment, tone control software may be loaded into flow control system 10 and the audio and/or video data that has been captured may be analyzed to determine whether any tones are present. A detected tone is interpreted by flow control system 10 as an event (described earlier), which is forwarded to data control manager 32. In response, data control manager 32 may send a command back to flow control system 10 to cause the specified commercial to be played. In this embodiment, data control manager 32 would initially configure flow control system 10 to set up the frequencies that will trigger an event in data control manager 32.

In another embodiment, encoder 26 may be configured to read signals that identify any or all of the numerous parameters that relate to how the information should be displayed, such as whether the information being transmitted will be displayed in monochrome or in color, whether it includes a monophonic or stereophonic broadcast, the appropriate frame size. etc. In such embodiments, the information that is received by encoder 26 may be routed through the appropriate portion of the circuitry in order to accommodate the requirements that are imposed by these parameters.

It should be noted that any or all of the above described and similar functions could be incorporated into a single computer, or that these functions may be incorporated in accordance with the choices of Internet users, content providers or others. It should also be noted that any or all of the actions that are conducted by flow control system 10 may be tracked and stored in a file or otherwise provided in a log, in order to assist with billing or other appropriate operations.

It is, therefore, apparent that there has been provided, in accordance with the present invention, a method and apparatus for delivering a composite information stream to a display. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A system for delivering a composite information stream over a computer network, comprising:
a media delivery device having a media device driver associated therewith;
a flow control system being independent of and communicating with said media delivery device and with a stored data source, wherein said flow control system is configured to receive data from said media delivery device and from said stored data source, and to control the flow of said media delivery device data and said stored data source; and
an encoder communicating with said flow control system to receive said controlled data flow.

2. A system as claimed in claim 1 further comprising:
an Internet media player which receives said data from said encoder and displays said data on a video monitor using an Internet browser;
a data classifier which associates identifiers with said data;
an identifier recorder which records the passage of a designated type of data to said Internet media player; and
an identifier collector which enters a plurality of said recorded passages into a common data file.

3. A method as claimed in claim 2 wherein said designated type of data is a commercial advertisement, and said common data file is an advertising log.

4. A system as claimed in claim 1 wherein said media delivery device provides live data.

5. A system as claimed in claim 1 wherein said media delivery device provides a television broadcast.

6. A system as claimed in claim 1 wherein said stored data is downloaded from a web server and stored on a computer linked to said encoder.

7. A system as claimed in claim 1 wherein said stored data includes commercial advertisements.

8. A system as claimed in claim 7 wherein said flow control system allows a user to obtain information about content displayed in said commercial advertisements.

9. A system as claimed in claim 8 wherein said flow control system allows a user to order products or services that are associated with said content.

10. A system as claimed in claim 7 wherein said flow control system provides updated information about said media delivery device data.

11. A system as claimed in claim 1 wherein said stored data is located in an audio video interleaved file or a graphics interchange formatted file.

12. A system as claimed in claim 1 wherein said flow control system is located in an electronic unit that is physically separate from said media delivery device.

13. A system as claimed in claim 1, wherein said flow control system is a software module, and further comprising a data control manager software module for passing control instructions to said flow control system.

14. A system as claimed in claim 13, further comprising a queue coupled to said flow control system for passing information related to a desired order of data delivery from said stored data source.

15. A system as claimed in claim 13 wherein said data control manager passes said control instructions via the Internet.

16. A system as claimed in claim 14 wherein said queue is remotely alterable.

17. A system as claimed in claim 16 wherein said queue is altered by transferring information over a computer network.

18. A system as claimed in claim 17 wherein said queue is altered by downloading information from the Internet.

19. A system as claimed in claim 16 wherein said queue is altered by pressing buttons on a telephone key pad.

20. A system as claimed in claim 1 wherein said flow control system monitors said media delivery device data for a control signal, and wherein said flow control system signals said data control manager of receipt of said control signal, and wherein said data control manager controls said flow control manager in response to said control signal.

21. A system as claimed in claim 20 wherein said control signal is an elapsed time.

22. A system as claimed in claim 20 wherein said control signal is embedded in said media delivery device data.

23. A system as claimed in claim 22 wherein said control signal is an audible tone.

24. A system as claimed in claim 1 further comprising a software log of events, said software log being created in response to said controlled data flow, said software log containing a record of the data passed to said encoder from said stored data source by said flow controller.

25. A system as claimed in claim 24 wherein said software log is transferable over the Internet.

26. A system as claimed in claim 1 wherein said media delivery device data is a television broadcast.

27. A system as claimed in claim 1 wherein said stored data is an advertisement.

28. A system as claimed in claim 14 wherein said queue is an advertisement queue.

29. A system as claimed in claim 24 wherein said software log is an advertising log.

30. A system for delivering a composite information stream over a computer network, comprising:
a plurality of data sources; and
a flow control system configured to:
receive data from two or more of said plurality of data sources and from a data control manager,
to selectively control the flow of data received from said plurality of data sources in response to commands from said data control manager, and
to pass said controlled data flow to an encoder as a composite information stream.

31. A system as claimed in claim 30 further comprising:
a media player communicating with said encoder to receive said composite information stream from said encoder;
a data classifier which associates identifiers with said data;
an identifier recorder which records the passage of a designated type of data to said media player; and
an identifier collector which enters a plurality of said recorded passages into a common data file.

32. A method as claimed in claim 31 wherein said designated type of identifier identifies a commercial advertisement, and said common data file is an advertising log.

33. A system as claimed in claim 30 wherein at least one of said plurality of data sources is a live data source and at least one of said data sources is a stored data source, and wherein said flow control system is configured to communicate with a data control manager to selectively pass, in response to commands from said data control manager, data from at least one of said live data sources and from one or more of said at least one stored data sources.

34. A system as claimed in claim 33 further comprising an encoder configured to receive said selectively pass data to transform said received data into a composite data stream.

35. A system as claimed in claim 33 wherein said flow control system includes an electronic queue.

36. A system as claimed in claim 33 wherein said stored data is downloaded from a web server and stored on a computer linked to said encoder.

37. A system as claimed in claim 30 wherein said flow control system includes an electronic queue.

38. A system as claimed in claim 30 wherein at least one of said plurality of data sources provides live data.

39. A system as claimed in claim 38 wherein at least one of said plurality of said data sources includes a video feed.

40. A system as claimed in claim 39 wherein said video feed is a television broadcast.

41. A system as claimed in claim 30 wherein at least one of said plurality of data sources provides stored data.

42. A system as claimed in claim 41 wherein said stored data includes commercial advertisements.

43. A system as claimed in claim 41 wherein said stored data is located in an audio video interleaved file, a graphics interchange formatted file, is located in a file that has been compressed according to joint photographic experts group standards, or is located in a file that has been compressed according to motion picture experts group standards.

44. A system as claimed in claim 41 wherein said stored data is downloaded from a web server and stored on a computer linked to said encoder.

45. A system as claimed in claim 44 wherein said stored data includes commercial advertisements.

46. A system for delivering a composite information stream to an output device, comprising:
a plurality of data sources;
a flow control system which receives data from one or more of said plurality of data sources and selectively passes data from one or more of said plurality of data sources to an encoder; and
a media player which receives said data from said encoder and delivers said data to a video display.

47. A method of delivering a composite information stream over a computer network, comprising:
obtaining data from a plurality of data sources;
receiving control signals from a flow control system interposed between said plurality of data sources and an encoder;
selectively passing data from one or more of said plurality of data sources to said encoder in response to said received control signals;
delivering said selectively passed data to said encoder;
transforming said selectively passed data into a composite data stream; and
delivering said composite data stream to a media player.

48. A method as claimed in claim 47 wherein selectively passing further comprises;
designating an order of transmission of data from two or more of said plurality of data sources;
inserting said data into an information stream in said designated order; and
passing said information stream to said encoder.

49. A method as claimed in claim 47 wherein obtaining said data further comprises:
placing a plurality of data identifiers in an order in accordance with said designated transmission order; and
transferring names of data sets that are associated with said data identifiers to said flow control system in said data identifier order.

50. A method as claimed in claim 49 wherein selectively passing further comprises:
loading a named data set into an encoder; and
transmitting said named data set to a media player.

51. A method as claimed in claim 49 further comprising passing said data identifiers to said flow controller in said data identifier order.

52. A system as claimed in claim 51 further comprising:
recording the passage of an identifier associated with a designated type of named data set to said Internet media player; and
entering a plurality of said recorded passages in a common data file.

53. A method as claimed in claim 52 wherein said designated type of identifier is a commercial advertisement, and said common data file is an advertising log.

54. A method as claimed in claim 47 wherein at least one of said plurality of data sources provides live data.

55. A method as claimed in claim 54 wherein said live data source is a video feed.

56. A method as claimed in claim 55 wherein said video feed is a television broadcast.

57. A method as claimed in claim 47 wherein at least one of said plurality of data sources provides stored data.

58. A method as claimed in claim 57 wherein said stored data resides in an audio video interleaved file, a graphics interchange formatted file, a file that has been compressed according to joint photographic experts group standards or a file that has been compressed according to motion picture expert group standards.

59. A method of delivering a composite information stream over a computer network, comprising:
capturing a first data set;
receiving a request for transmission of at least a second data set;
designating an order of transmission of said first and at least said second data sets; and
controlling the flow of data from said first data set and at least said second data set in accordance with said designated order.

60. A method as claimed in claim 59 further comprising:
delivering said controlled flow to a media player;
associating identifiers with said data;
recording the passage of a designated type of identifier to said media player; and
entering a plurality of said recorded passages in a common data file.

61. A method as claimed in claim 60 wherein said designated type of identifier is a commercial advertisement, and said common data file is an advertising log.

62. A method as claimed in claim 59 wherein said output device is a video monitor.

63. A method as claimed in claim 59 wherein said output device is a personal digital assistant.

64. A method as claimed in claim 59 wherein said order designating step further comprises retrieving a predetermined data transmission order from an electronic queue.

65. A method as claimed in claim 59 wherein at least one of said data sets includes live data.

66. A method as claimed in claim 65 wherein a source of said live data is a video feed.

67. A method as claimed in claim 66 wherein said video feed is a television broadcast.

68. A method as claimed in claim 59 wherein at least one of said data sets delivers stored data.

69. A method as claimed in claim 68 wherein said stored data is in an audio video interleaved file, a graphics interchange formatted file, a file that has been compressed according to joint photographic experts group standards or a file that has been compressed according to motion picture experts group standards.
